(19) United States
(12) Patent Application Publication
(10) Pub. No.: US 2004/0195068 A1
(43) Pub. Date: Oct. 7, 2004

(54) Clutch arrangement

(75) Inventor: Jorg Sudau, Niederwerrn (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/802,603

(22) Filed: Mar. 17, 2004

(30) Foreign Application Priority Data
Apr. 3, 2003 (DE) 103 15 169.9

(51) Int. Cl. F16D 13/72; F16D 33/00

(52) U.S. Cl. 192/70.12; 192/113.34

(57) ABSTRACT

A clutch arrangement, especially for a motor vehicle, comprises a housing arrangement which can be filled with fluid; at least one first friction element connected to the housing arrangement for rotation in common around an axis of rotation; and at least one second friction element connected to a power takeoff element for rotation in common around the axis of rotation (A), which second element can be brought into contact with at least one first friction element to produce a frictional interaction. The at least one first friction element or the at least one second friction element has a friction lining carrier which carries a friction lining arrangement on each frictionally active axial side of the friction element. At least in the case of one friction element with a friction lining carrier carrying a friction lining arrangement an arrangement of fluid transport surfaces is provided to produce a circulation of fluid which flows around at least certain areas of the friction elements.

### BACKGROUND OF THE INVENTION

1. Field of the Invention

The present invention pertains to a clutch arrangement, especially for a motor vehicle, comprising a fluid-filled or fluid-fillable housing arrangement; at least one first friction element, which can rotate in common with the housing arrangement around an axis of rotation; and at least one second friction element, which can rotate in common with a power takeoff element around an axis of rotation, which second friction element can be brought into contact with at least one first friction element to produce a frictional interaction.

2. Description of the Related Art

A clutch arrangement of this type is known from DE 101 25 628 A1. In an embodiment shown in this publication, the first and second friction elements, i.e., the friction lining carriers of these elements, carry a friction lining on one axial side, whereas, on the other axial side, the friction lining carrier enters directly into frictional interaction with a friction lining of the friction element following next in the axial direction. The result of this is that, in spite of the ability of the various fluid transport surfaces to build up a circulation of fluid flowing around the friction elements, the friction elements are subjected to extreme thermal stress in the area of their friction lining carriers, which are usually made of metal sheet or plate material. As a result of the good thermal conductivity of these friction lining carriers, the heat thus developing in or being taken up by each of the friction lining carriers is distributed very quickly and uniformly over the entire volume of the carrier and thus also arrives in the area where the friction lining carrier in question is attached, usually by means of an adhesive, to the friction lining it is supporting. This puts stress on the adhesive bond, and, in the extreme case, that is, for example, when the housing is only partially filled with fluid and the clutch has been slipping for a relatively long period of time, this can lead to the separation of a friction lining or at least to partial damage to the adhesive bond. This publication also describes clutch arrangements in which first and section friction elements each have friction linings on both sides of a friction lining carrier. Between two of the first friction elements, which carry friction linings on both axial sides, there is always a second friction element present, which is designed as a plate and which does not carry any friction linings, and vice versa. With this arrangement, however, it is necessary to insert an intermediate friction element which does not carry any friction linings into the area in which a first friction element with friction linings on both sides is directly adjacent to a second friction element carrying friction linings on both of its axial sides. In this case, therefore, two friction elements connected nonrotatably to, for example, the housing, are directly adjacent to each other, which means that axial space is taken up without the gain of an additional pairing of friction surfaces.

### SUMMARY OF THE INVENTION

It is the task of the present invention to improve the design of a clutch arrangement of the general type in question in such a way that the thermal stress, especially in the area of the friction elements, can be reduced while at the same time it is possible to provide an arrangement which is compact in the axial direction.

According to the invention, the at least one first friction element or the at least one second friction element has a friction lining carrier, which carries a friction lining arrangement on each frictionally active axial side of the friction element, and that, at least in the case of one friction element with a friction lining carrier carrying a friction lining arrangement, an arrangement of fluid transport surfaces is provided to produce a circulation of fluid flowing around at least certain parts of the friction elements.

By providing friction elements which carry friction linings on each frictionally active side and by providing friction elements which do not carry any friction linings, the goal is achieved that the friction elements on which friction linings are provided are subjected to less thermal stress because of the thermally insulating effect of the friction linings. This has the result that there is no danger of damage, especially when there is an adhesive bond between the friction lining and the friction lining carrier. On the contrary, the heat that develops when the clutch is slipping is absorbed more effectively by the friction elements carrying no friction linings on either frictionally active side, these thus being areas where there is no danger of damage to, for example, an adhesive bond.

As a result of the design according to the invention, it is possible, without affecting the ability to create effective circulation in the area of the friction elements, for two first friction elements not to follow each other directly in the axial direction and for two second friction elements not to follow each other directly in the axial direction. Thus, all of the friction elements provided, i.e., all of the elements connected nonrotatably either to the housing arrangement or to the power takeoff element, are frictionally active to the greatest possible extent, and no dead, i.e., frictionally noninteracting, surface pairings are present, which, for a given number of friction surface pairings, reduces the axial length of the unit or, for a given axial length, allows the installation of a larger number of surface pairings capable of interacting frictionally with each other.

The friction elements that do not have friction linings can, for example, be designed in the form of plates. These plates are preferably made of metal.

So that an advantageous fluid circulation can be produced in a very simple way to reinforce the removal of the heat from the area of the frictionally interacting surfaces, it is proposed that the arrangement of fluid transport surfaces on a friction lining arrangement and/or a friction lining carrier comprise at least one fluid transport surface oriented in the circumferential direction.

This can be achieved by arranging a plurality of friction lining segments in a row around the circumference of the friction lining arrangement, so that the circumferential surfaces of these segments which face each other form at least a part of the fluid transport surface arrangement. Alternatively or in addition, it is also possible for the friction lining carrier to have at least one friction lining carrier segment which has a circumferentially oriented surface which forms at least a part of the fluid transport surface arrangement.

Especially when the friction linings are segmented, that is, when they comprise separate sections extending in a row around the circumference, it is advantageous for the sake of efficient fluid circulation for the outside contour of the area of a friction lining carrier segment which carries the friction lining segment to conform essentially to the outside contour of the friction lining segment supported thereon.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal cross section through a so-called “wet-running” clutch arrangement;

FIG. 2 shows an axial view of a friction element which can be used in the clutch arrangement of FIG. 1;

FIG. 3 shows a perspective view of the friction element of FIG. 2;

FIG. 4 shows an axial view of another friction element which can be used in the clutch arrangement of FIG. 1; and

FIG. 5 shows a perspective view of the friction element of FIG. 4.

### DETAILED DESCRIPTION OF THE PRESENTLY PREFERRED EMBODIMENTS

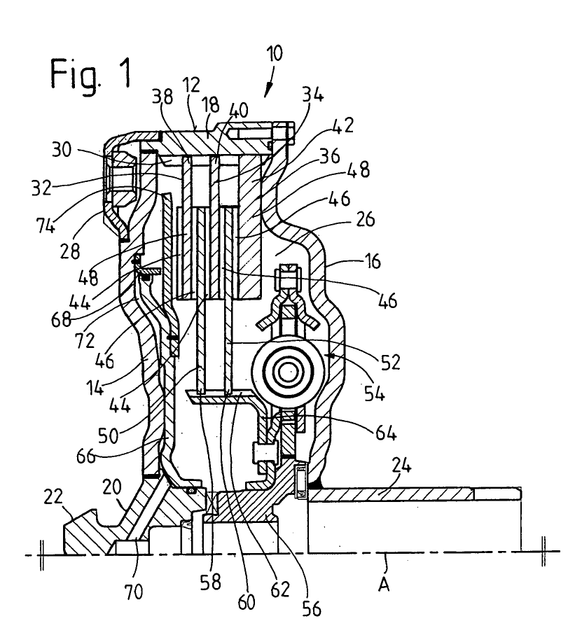

FIG. 1 shows a wet-running clutch arrangement 10 according to the invention. The clutch arrangement 10 comprises a housing 12, which has two essentially disk-like housing parts 14, 16, connected to each other in their outer radial areas by means of a ring-like housing part 18. The housing part 14 is also connected in its radially inner area to a housing hub 20, which carries a bearing journal 22. The journal engages with, for example, an appropriate centering receptacle in a drive shaft. The housing part 16 is rigidly connected radially on the inside to a so-called pump hub 24, by means of which a pump, mounted, for example, on a gearbox, can be operated to build up a fluid pressure, so that fluid can be supplied to the interior 26 of the housing 12. The housing 12 can be connected nonrotatably to a drive shaft, such as the crankshaft of an internal combustion engine, at several connecting points 28 by means of a flexplate or the like.

The radially outer, ring-like housing part 18 has on its inner surface a set of gear teeth 30, which extends longitudinally essentially in the same direction as the axis of rotation A. In the present example, three friction elements 32, 34, 36 have complementary sets of teeth 38, 40, 42 by which they engage with this set of teeth 30. In this way, these friction elements 32, 34, 36 are connected nonrotatably to the housing 12 but still have the freedom to move in the same direction as that of the axis of rotation A.

Each of the friction elements 32, 34, 36 has a friction lining 44, 46 on its frictionally active side; this friction lining is supported on a friction lining carrier 48. Whereas the two friction elements 32, 34 have friction linings 44, 46 on both sides of the associated friction lining carrier 48, the friction element 36 positioned all the way to the right in the diagram of FIG. 1 and supported on one side against the housing part 16 is not provided with friction linings on both sides of the friction lining carrier 48 but rather only on the side against which this friction element 36 is also frictionally active. No friction lining is provided on the side serving merely for axial support.

Friction elements 50, 52, which are connected not to the housing 12 but rather to a power takeoff element such as, for example, a power takeoff shaft (not shown in FIG. 1), for rotation in common, are interleaved between the friction elements 32, 34, 36. In the case shown here, this connection for rotation in common is accomplished by means of a torsional vibration damper, designated 54 overall, and a power takeoff hub 56. The two friction elements 50, 52 can be designed in the form of plates, and, like the friction lining carrier 48, can be made of metal sheet or plate material. Radially on the inside, each element has a set of teeth 58, 60, which is designed to mesh with a set of teeth 62 on a driven part 64, which is connected nonrotatably to the power takeoff element or which possibly is itself to be considered a power takeoff element. Thus the friction elements 50, 52 are also able to move axially with respect to this driven part 64 but are connected nonrotatably to it.

A piston element 66, which is held with freedom to move in the same direction as that of the axis of rotation A, extends between the hub 20 and a guide element 68 provided on the housing part 14. The piston element is guided in a fluid-tight manner on these two latter components by the use of sealing elements. Fluid can be introduced into an intermediate space 72 formed or to be formed between this piston element 66 and the housing part 14 through a plurality of fluid flow openings 70. The introduction of this fluid, i.e., the increase in the fluid pressure in this space 62 with respect to the interior space 26 of the housing 12, has the effect of pushing the piston element 66 and thus a thrust element 74 connected rigidly to it toward the other disk-like housing part 16. Thus the thrust element 74 comes into frictional contact with the friction lining 44 of the friction element 32 and pushes the opposing surfaces of the friction elements 32, 50, 34, 52, 36 into contact with each other.

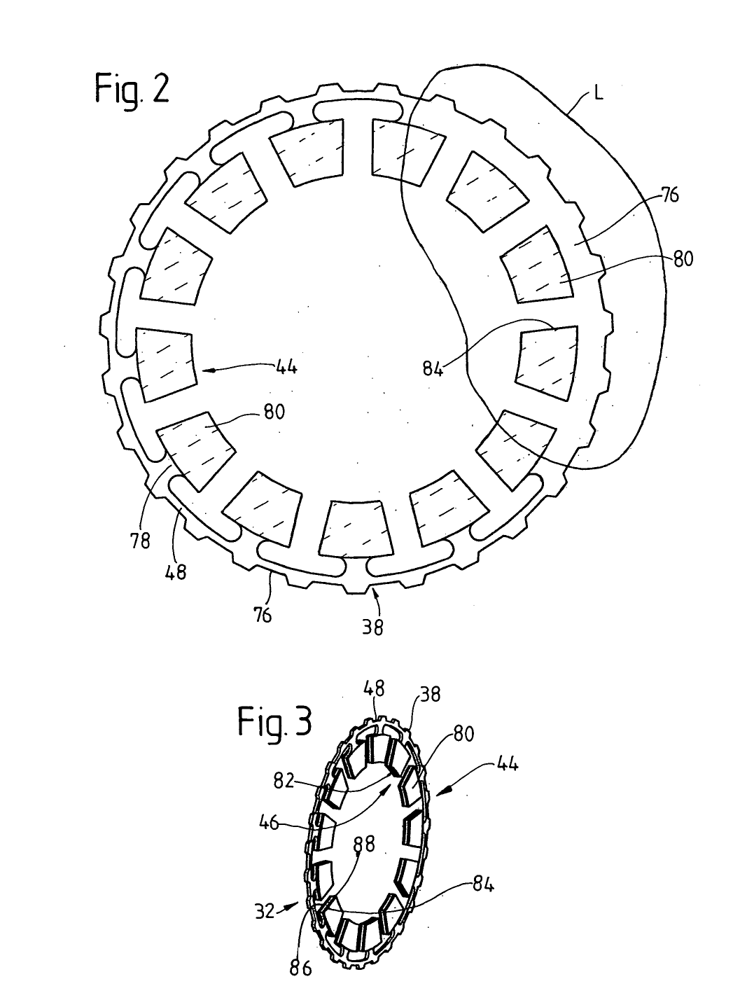

On the basis of the friction element 32, FIGS. 2 and 3 show the basic design of the friction elements 32 and 34, which are connected nonrotatably to the housing 12. It can be seen that, in general, the friction lining carrier 48, made, for example, of steel or some other metal, has a radially outer, ring-like body section 76, on the outer circumferential area of which the set of teeth 38 is formed. Several lining carrier segments 78 extend radially toward the inside from this body section 38. A friction lining segment 80, 82 of the associated friction lining 44, 46 can be seen on both axial sides of these lining carrier segments 78, the friction linings thus consisting of a plurality of friction lining segments.

As a result of this segmentation of the friction linings 44, 46 and of the friction lining carrier 48 with its lining carrier segments 78, circumferentially oriented surfaces 84, 86, 88 are created on the friction lining segments 80, 82 and the lining carrier segments 78. Because the outer contour of the area of the lining carrier segments 78 which carry the friction lining segments 80, 82 conforms to the outer contour of the lining segments 80, 82, the three above-mentioned surfaces 84, 86, 88 together create an overall fluid transport surface for each group made up of a lining carrier segment 78 and two friction lining segments 80, 82. Upon the rotation of the housing 12, therefore, the friction elements 32, 34 and also the friction element 36, which, at least in the area of its friction lining 46, can also offer these types of circumferentially oriented surfaces, cause the fluid to circulate; this circulation flows around the friction elements in the area of their frictionally interacting surfaces.

The circulation of fluid in the area of the frictionally interacting surfaces ensures that the frictional heat which develops especially when the clutch is slipping is removed from the area of the friction elements and transported away via the fluid present in the interior space 26 more efficiently and more quickly. Thus the thermal load on the various friction elements can be reduced.

An essential aspect of the clutch arrangement shown in FIG. 1 is that a friction element 32, 34, 36 which is connected nonrotatably to the housing 12 always follows, in the axial direction, a friction element 50, 52 which is connected nonrotatably to the power takeoff element 64 and that only one of the groups of these friction elements (in the example shown in FIGS. 1-3, the friction elements 32, 34, 36, which are connected nonrotatably to the housing 12) carry friction linings, these linings 44, 46 being carried on all of the frictionally active axial sides of these friction elements. It is therefore impossible for a case to occur in which a friction lining carrier which, for example, carries a friction lining segment on only one axial side or, in general, carries only one friction lining, to enter into direct frictional interaction on its other axial side without the intermediate presence of some type of thermally insulating element. As a result, in the design shown in FIG. 1, most of the frictional heat which develops while the clutch is slipping is absorbed by the plate-like friction elements 50, 52 not carrying friction linings on either side. The friction elements 32, 34, 36 carrying friction linings 44, 46 are frictionally active only in the area of these friction linings. This reduces the load especially on the permanent connection, usually produced by an adhesive, of the friction linings 44, 46 to their associated friction lining carriers 48, because the friction linings 44, 46 are usually comparatively good thermal insulators.

It can therefore be seen from the preceding description of the arrangement that, in the clutch arrangement according to the invention, only one of the groups of friction elements, e.g., the friction elements connected to the housing 12, therefore contribute to the buildup of the fluid circulation, whereas the other group of friction elements behaves in a generally neutral fashion with respect to the production of this fluid circulation.

In the area enclosed by the line L in FIG. 2, a variant is shown, in which the ring-like body area 76 of the friction lining carrier 48 extends all the way to the radially inner end of the friction lining segments 80, 82. Here, therefore, the fluid transport effect is caused only by the circumferentially oriented sides or surfaces 84, 86 of the friction lining segments 80, 82. In principle, it would also be possible to use the inverse arrangement, in which, in the area not enclosed by the broken line L, the friction lining carriers 48 still have the lining carrier segments 78 shown, but the friction linings 44, 46 are designed not as segments but rather as continuous rings. Only the circumferential surfaces 88 of the lining carrier segments 78 present between the two ring-like friction lining segments are therefore left, and only these circumferential surfaces contribute to the fluid transport effect. In this variant, the surface area which contributes to the transport of fluid is reduced, but the surface area which becomes frictionally active is increased, and thus the load on the friction linings can be reduced.

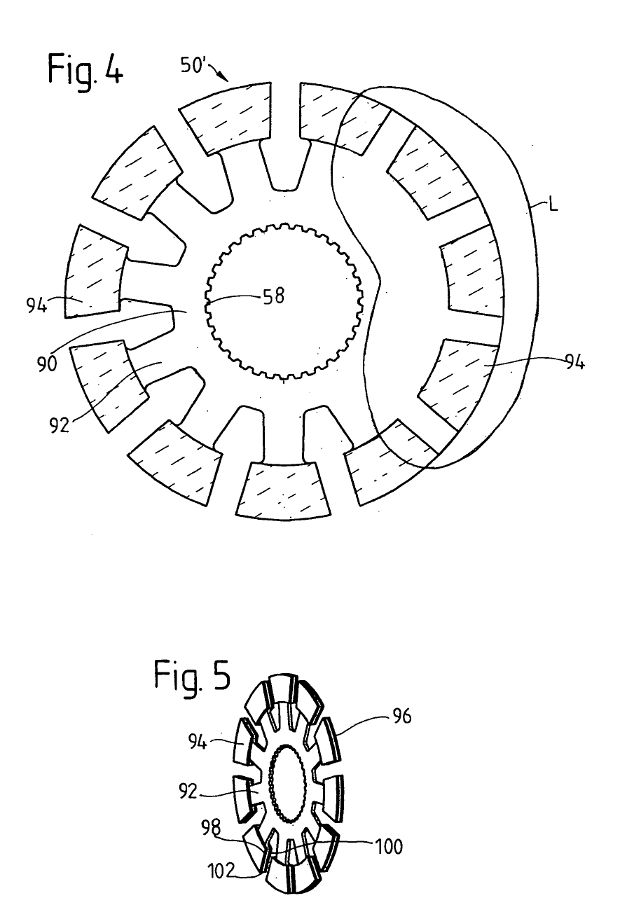

The previously described effects can also be achieved when the functionality of the two groups, i.e., the group of friction elements 32, 34, 36 and the group of friction elements 50, 52, are exchanged. That is, it is still possible to cause the fluid to circulate even if the friction linings are provided not on the friction elements connected nonrotatably to the housing 12, but rather on the friction elements connected nonrotatably to the power takeoff element, no friction linings being provided on the other friction elements. FIGS. 4 and 5 show a modified friction element 50′ for this purpose. It can be seen that this has a ring-like, circumferential body area 90, which now carries the set of teeth 58 on its inner circumferential side. Lining carrier segments 92 proceed radially outward from this ring-like body area 90, and these segments now carry lining segments 94, 96, one on each of their two axial sides. Here again, the friction lining segments 94, 96 on the lining carrier segments 92 create circumferentially oriented surfaces 98, 100, 102, which, upon rotation, contribute to the circulation of the fluid. It is again possible to use a design as shown in the area of the friction element 50′ enclosed by the line L. Here the friction lining carrier is not segmented in conformity with the friction lining segments, and as a result the fluid transport effect is produced here only by the circumferentially oriented surfaces of the friction lining segments 94, 96.

The arrangement in which the friction elements 50, 52, which are connected nonrotatably to the power takeoff element on the radially inner side, are designed as shown in FIGS. 4 and 5 is advantageous with respect to the amount of axial space required to the extent that, when the two friction elements 32, 34 which are connected on the radially outer side are designed as plates, the friction lining 44 between the friction element 32 and the thrust element 74 shown in FIG. 1 would no longer be present. The friction lining 44 on the friction element 32 facing the thrust element 74 could also be eliminated even in the variant shown in FIGS. 1-3, because the thrust element 74 and the piston element 66 are usually connected nonrotatably to the housing 12, at least by virtue of the frictional effect present in the area of the sealing elements. The basic principle of the invention would still be fulfilled that, in the case of a friction element with a friction lining on one axial side, there is never any direct frictional interaction on the other axial side between its friction lining carrier and another friction element.

It should be pointed out that the principles of the invention also apply, of course, to arrangements with other numbers of the various friction elements. For example, in the embodiment according to FIG. 1, the friction element 34 and the friction element 52 could both be omitted, so that there is only one friction element connected nonrotatably to the power takeoff side. This applies correspondingly to the case in which the friction elements contributing to the fluid transport effect are connected nonrotatably to the power takeoff side.

It should be pointed out that, in accordance with the present invention, with respect to the surfaces which contribute to the transport of fluid, the expression “circumferentially oriented” covers not only the case shown in the figures, in which the normals to the surface in question have a circumferential or tangential orientation. Surfaces at a certain angle to this circumferential or tangential direction, that is, surfaces with a surface normal which is at a certain angle to a plane at a right angle to the axis of rotation, but which still have a circumferential component when broken down into their vectors, are also to be understood as “circumferentially oriented” surfaces in the sense intended by the preceding discussion.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch arrangement for a motor vehicle, said arrangement comprising:
a housing which can be filled with fluid and can be rotated about an axis;
at least one first friction element connected to said housing for rotation in common about said axis, each said first friction element having at least one frictionally active axial side; and
at least one second friction element connected to a power takeoff element for rotation in common about said axis of rotation, each said second friction lining element having at least one frictionally active axial side which con be brought into frictional engagement with a respective said frictionally active side of said at least one first friction element;
wherein one of the at least one first friction lining element and the at least one second friction lining element comprises a friction lining carrier having a friction lining arrangement on each said frictionally active side of said one friction element, said one friction element comprising an arrangement of fluid transport surfaces which causes fluid to circulate around parts of said friction elements.

2. A clutch arrangement as in claim 1 wherein two of said second friction lining elements are interleaved between three of said first friction lining elements.

3. A clutch arrangement as in claim 1 wherein one of said at least one first friction lining element and said at least one second friction lining element is in the form of a plate having no friction lining.

4. A clutch arrangement as in claim 1 wherein said arrangement of fluid transport surfaces comprises at least one circumferentially oriented fluid transport surface provided on at least one of said friction lining carrier and said friction lining arrangement.

5. A clutch arrangement as in claim 4 wherein said friction lining arrangement comprises a plurality of friction lining segments arranged in a circumferential row and having circumferentially directed surfaces, said arrangement of fluid transport surfaces comprising said circumferentially directed surfaces.

6. A clutch arrangement as in claim 5 wherein said friction lining carrier comprises a plurality of friction lining carrier segments having circumferentially directed surfaces, said arrangement of fluid transport surfaces comprising said circumferentially directed surfaces of said friction lining carrier.

7. A clutch arrangement as in claim 6 wherein each said friction lining carrier segment has an outer contour, and each said friction lining segment has an outer contour which conforms essentially to the outer contour of one of said friction lining carrier segments.
